(19) United States
(12) Patent Application Publication
(10) Pub. No.: US 2002/0145280 A1
(43) Pub. Date: Oct. 10, 2002

(54) Medical folder for use with electronic devices

(76) Inventor: Richard Bock, Santa Monica, CA (US)

Correspondence Address: Jeffrey Furr, 176 Saratoga Drive, Johnstown, OH, 43031, US

(21) Appl. No.: 09/829,041

(22) Filed: Apr. 9, 2001

(51) Int. Cl. B42D 1/00; B42D 5/00; B42D 9/00

(52) U.S. Cl. 281/15.1

(57) ABSTRACT

The current invention is a fold-open, clipboard-sized medical folder, made of leather or vinyl over reinforced cardboard, which holds a paper medical record (or other document) on one side and an electronic computer device on the other. It is designed to facilitate the incremental transition from paper to electronic record keeping. Both paper document and electronic device are removable to allow for separate movement throughout the office. The invention has a series of 3-4 “flags” mounted as colored pull tabs or on/off, colored lights visible on the lateral external surface, for use as interoffice alerts and in chart routing instructions.

### CROSS-REFERENCES TO RELATED APPLICATIONS (IF ANY)

None

### STATEMENT AS TO RIGHTS TO INVENTIONS MADE UNDER FEDERALLY-SPONSORED RESEARCH AND DEVELOPMENT (IF ANY)

None

### BACKGROUND

1. Field of the Invention

This invention relates to art of medical folders, specifically an improvement for the use with electronic devices.

2. Description of Prior Art

With the movement of the medical professional to electronic medical records there is a need for a easy, inexpensive and convenient method for use by healthcare practitioners who currently uses a paper chart and wishes to adopt electronic medical records. There exists a need for a device is that will accommodate both a paper chart and an electronic device side by side in an ergonomic fashion to allow data entry on either or both elements. This would allow a medical practitioner to transition incrementally from paper to electronic records at his/her own pace.

The current method is to rely only on paper records, or to use paper records and then have someone enter that information into an input device to make an electronic record. There is costly in time and expense and is not the most efficient use of resources. It is very time intensive process. It requires the data to enter twice and to be maintained at two different locations. This is a need for a device that can help an office practice add electronic functionality over time, while fitting into whatever the existing office information flow is.

In prior art, U.S. Pat. No. 5,613,791 by Medenick for a medical file folder, U.S. Pat. No. 6,032,984 by Ishida for a Mid-digit color coded filing system and folders and U.S. Pat. No. 6,142,529 by Liao for a Structure of a combination file folder are all methods of storing and filing records. They do not provide a method of holding records for the purpose of efficient intra-office routing and data entry alongside an electronic element. Other tabbed and colored file devices are for the express purpose of storing and retrieving patient charts.

There is prior art that provides for a carrying case for electronic devices and some for both electronic device and a calendar or paper. But none have the combination of this device; namely, a carrying capability for a medical chart attached by spring clip, a medical computer holder, spaces for lab and x-ray slips, prescription pad and with a colored flag system for office routing.

There is still room for improvement within the art.

3. Field of the Invention

U.S. Class 283/70

4. Description of Related Art Including Information Disclosed Under 37 CFR §1.97**> and 1.98<.

None

### SUMMARY OF THE INVENTION

It is the object of this invention to provide an easy, inexpensive and convenient method for use by healthcare practitioners who currently uses a paper chart and wishes to adopt electronic medical records. The current invention is a device that consists of a folder with carrying capability for a medical chart attached by spring clip, an electronic device holder, spaces for lab and x-ray slips, prescription pad and a colored flag system for office routing. It is a fold-open, clipboard-sized portfolio, made of leather or vinyl over reinforced cardboard, which holds a paper medical record (or other document) on one side and an electronic data entry device on the other. It is designed to facilitate the incremental transition from paper to electronic record keeping.

In the current invention, both paper documents and electronic devices are removable to allow for separate movement throughout the office. The documents are fastened by means of a clip or insert area on the medical folder, which is reversible for either left or right hand user. The electronic device, such as a lightweight pen-based touch screen element, can be a self-contained tablet PC or a screen element with wire or wireless connection to a portable computer unit mounted on the medical folder or carried by the user. The electronic device can be permanently mounted or attached by straps or Velcro.

There can be two or more pockets on the portfolio for additional loose paper records, such as lab, x-ray, consultant reports; and a holder for a written prescription pad. In addition, there can be a holder for a mobile phone (or PDA) device and their connections to a computer. There are a series of 3-4 “flags” mounted as colored pull tabs or on/off, colored lights visible on the lateral external surface, for use as interoffice alerts and in chart routing instructions.

The current device is designed to color code the required method of data entry (paper vs. electronic) and to code the approved route of intra-office medical record flow and follow up.

### OBJECTS AND ADVANTAGES

Over time, as more electronic functionality is adapted by the practice, the reliance on paper records is diminished and eventually eliminated. The current invention can be used to accommodate new patients with transferred paper charts and for flagging the patients with transitional records or with the occasional paper elements that continue to need attention before they can be scanned in.

The current device can be used by any healthcare practitioner who currently uses a paper chart and wishes to adopt electronic medical records. The advantage of this device is that it is unique in its ability to accommodate both a paper chart and an electronic device side by side in an ergonomic fashion to allow data entry on either or both elements. In this way, the practitioner is allowed to transition incrementally from paper to electronic records at his/her own pace.

As part of a medical records system, this device can uniquely help an office practice add electronic functionality over time, while fitting into whatever the existing office information flow is. The current invention is more convenient, effective, cheaper and functional than the current art.

### BRIEF DESCRIPTION OF THE DRAWINGS

Without restricting the full scope of this invention, the preferred form of this invention are illustrated

FIG. 1 is an open view of the medical folder;

FIG. 2 is a close view of front of the medical folder;

FIG. 3 is side view of the bending fold;

FIG. 4 is a front perspective view of the medical folder;

FIG. 5 displays a method of connecting an electronic device to the medical folder,

FIG. 6 displays another method of connecting an electronic device to the medical folder;

FIG. 7 displays the stylus/pen holder,

FIG. 8 shows how a prescription pad fits into the medical folder;

FIG. 9 shows how a color tab fits in the color tab channel; and

FIGS. 10A and 10B displays the use of color on/off lights for a flagging system.

### DESCRIPTION OF THE PREFERRED EMBODIMENT(S)

The preferred embodiment of the invention is described below.

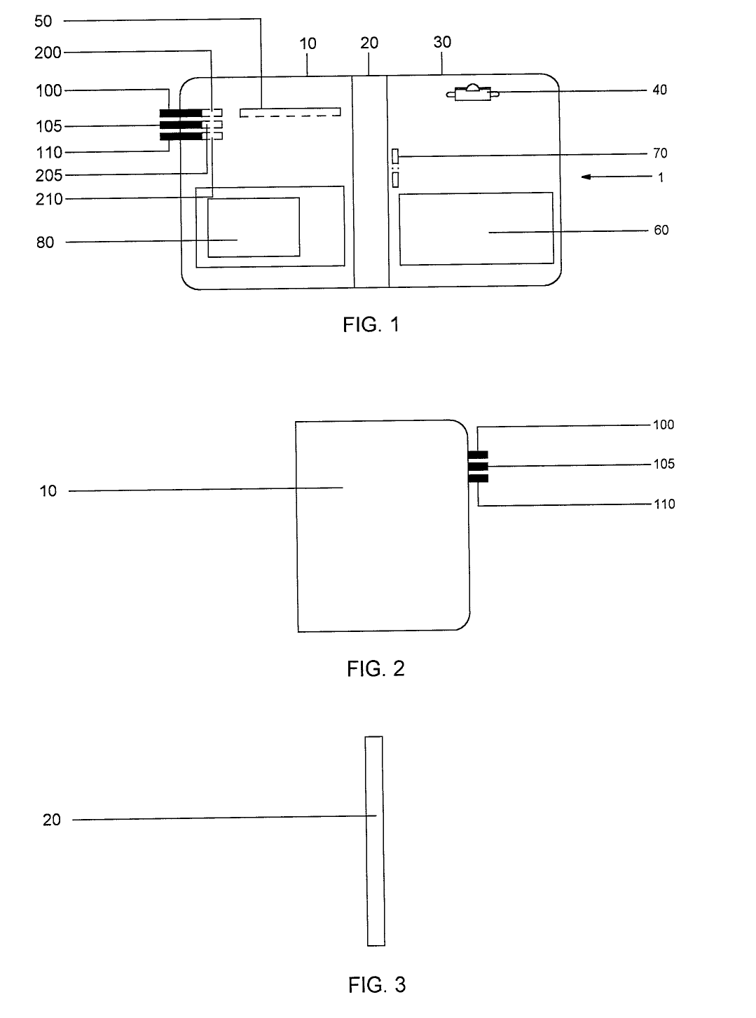

As shown is FIG. 1, the Medical Folder 1 consists of a standard folder configuration that has two halves, a left half 10 and a right half 30. It has a central fold 20. In the preferred embodiment, the medical folder 1 is made of a vinyl or leather material with reinforced cardboard inside the left half 10 and the right half 30. There is no re-enforced cardboard inside of the central fold 20. This gives the central fold 20 the flexibility that will allow the left half 10 and the right half 30 to fold towards each other allowing the Medical Folder 1 to be closed. The left half 10 and right half 30 have dimensions of 10″ wide by 12″ long. The central fold 20 is 2″ wide by 12″ long.

The left half 10, central fold 20 and the right half 30 have an interior and exterior side. FIG. 1 displays the interior side. FIG. 2 displays the exterior side of the left half 10 In the preferred embodiment it is plain, but it may contain a color, display or design that would enhance it usefulness in a medical office. The design could used to signify the specific office the medical folder 1 is being used by or the type of record. FIG. 3 displays the exterior side of the central fold 20.

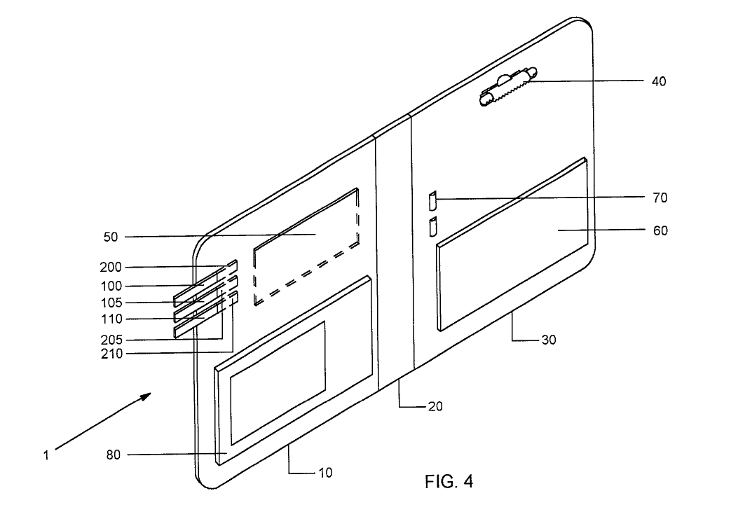

FIGS. 1 and 4 shows the interior sides of the left half 10, central fold 20 and the right half 30. The right half 30 has an attachment means such as a spring clip 40 on the upper portion. The spring clip 40 is one that is standard to the industry. The attachment means is used to hold documents such as medical records or X-rays. In the preferred embodiment, the right half 30 has a stylus/pen holder 70. The stylus/pen holder 70 is made by 1″ inch loops of vinyl or leather that come out from the surface of the right half 30. The right half 30 has a loose slip pocket 80 for loose slips and papers. The loose slip pocket 60 preferred dimensions are 8 75″ wide by 4″ long. The loose slip pocket 60 is made will a piece of vinyl or leather that can be connected to the right half 30 through the use of a connecting mean such as an industry standard glue applied to the edges or use of heat press or stitching.

The interior of the left half 20 has a prescription pad slit 50 on the upper portion. The left half 10 has single or multiple sliding color tabs 100, 105, and 110. These sliding tabs can be different colors to be used for a flag system for office routing. The sliding color tabs are ⅛″ thick, ½″ wide and 2″ long and are made of a sturdy plastic. The sliding color tabs 100, 105 and 110 are in sliding tab channels 200, 205 and 210. The sliding tab channels are areas in the left half 20 where material has been removed from the re-enforced cardboard backing (or between the backing and the covering). The left half 20 has openings at the end of the sliding tab channels 200, 205 and 210 which the sliding color tabs 100, 105 and 110 move partially in and out of

The electronic device 80, which can be a lightweight pen-based touch screen element or a similar such device, is attached to the left half 20. The electronic device 80 can be either attached permanently by either being bolted to the left half 20 by use of a strong epoxy glue or attached temporary through the use of straps or Velcro.

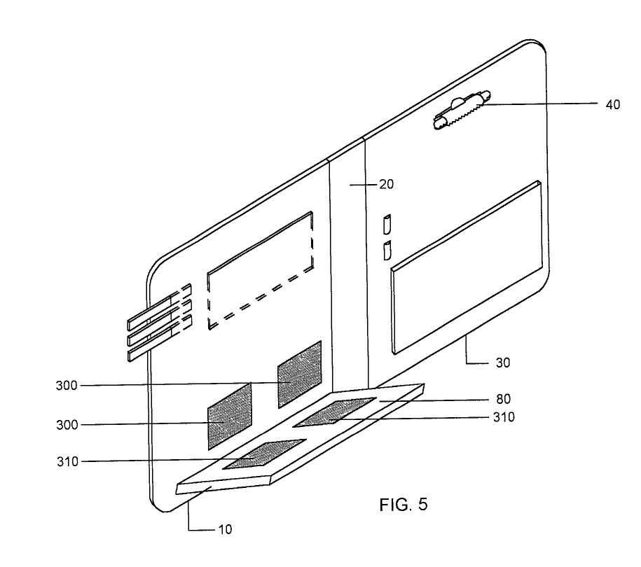

FIG. 5 displays one method of attaching an electronic device 80 to the Medical Folder 1. The left half 20 as a plurality of Medical Folder Velcro strips 300 on its lower portion. The electronic device 80 has a plurality of Electronic Device Velcro strips 310 on its back that are spaced the same as the Medical Folder Velcro strips 300. The electronic device 80 is secured to the Medical Folder 1 by pressing the Medical Folder Velcro strips 300 against the electroinc device Velcro strips 310. This is just one of many connections means by which the electronic device 80 can be attached to the Medical Folder 1.

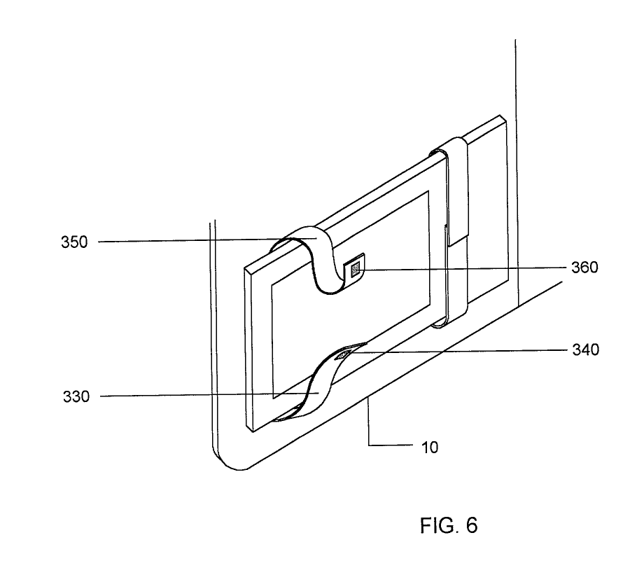

FIG. 6 displays another method of attaching an electronic device 80 to the Medical Folder 1. Leather or vinyl straps are attached to the Medical Folder 1. These straps have Velcro strips on the end of them. The bottom straps 330 have the bottom strap Velcro 340 on the top of them while the top straps 350 have the top strap Velcro 360 on the bottom of them. The top strap Velcro 360 attaches to the bottom strap Velcro 340 latching the electronic device 80 to the medical folder 1. In the alternative, a stand hole and buckle method could be used.

The electronic device, such as a lightweight pen-based touch screen element, can be a self-contained tablet Personal Computer or a screen element with wire or wireless connection to a portable computer unit mounted on the medical folder or carried by the user.

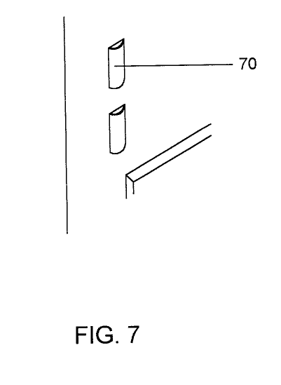

FIG. 7 shows a stylus/pen holder 70 is made by 1″ inch loops of vinyl or leather that come out from the surface of the right half 30. A stylus 270 is held in the stylus/pen holder 70.

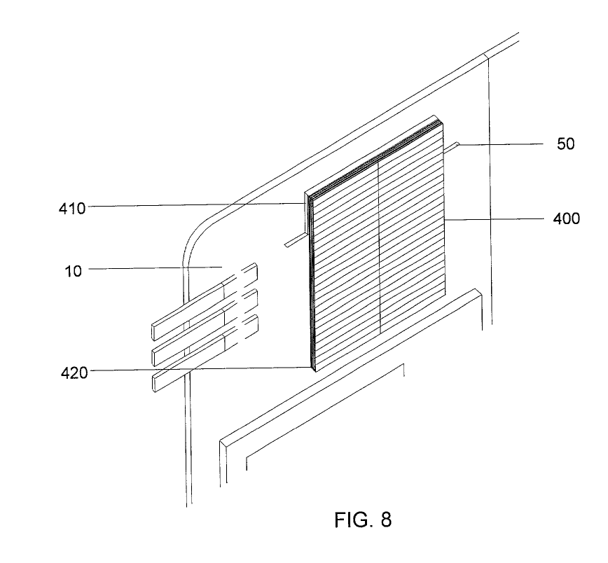

FIG. 8 displays how a prescription pad 400 is inserted into the prescription pad slit 50. The cardboard back 410 of the prescription pad 400 is inserted into the prescription pad slit 50 with the prescription sheets 420 on the outside of the prescription pad slit 50.

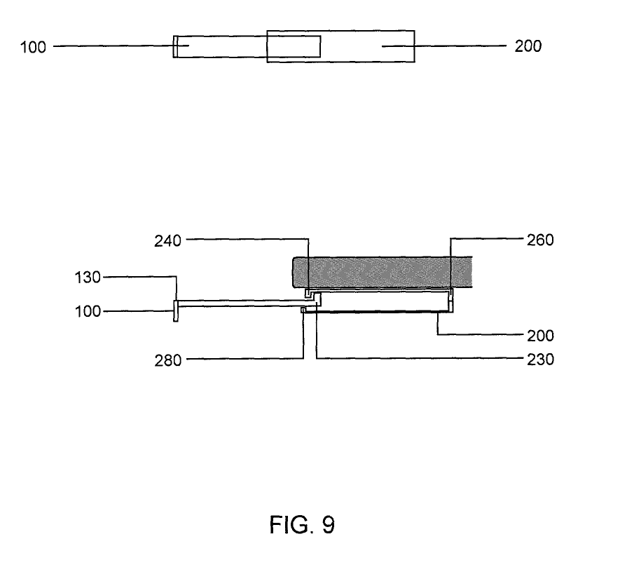

FIG. 9 shows a sample of a single color tabs 100. The sliding color tabs form the flag system for office routing and may be of multiple colors each color signifying information about the file. The sliding color tabs are ⅛″ thick, ½″ wide and 2″ long and are made of a sturdy plastic. The color tab 100 has two lips 130 and 230 on its ends. One lip 130 is used by the user to move the color tab 100 out or in the color tab channel 200. The other lip 230 is used to stop the color tab 100 from being pulled out of the color tab channel 200. The lip 230 catches on a channel lip 240 that is on the end of the color tab channel 200 that is closest to the tab opening 300. The lip 230 also stops the color tab 100 from going past the end 260 of the color tab channel 200. The sliding color tab 100 fits in the sliding tab channel 200. The sliding tab channel 200 are areas in the left half 20 where material has been removed from the re-enforced cardboard backing, or between the backing and the cover. The left half 20 has a tab opening 280 at the end of the sliding tab channel 200 which the sliding color tab 100 sticks out of. The color tab's 100 fit in the color tab channel 200 is tight. This allows friction to hold the color tab 100 stay in the position that it was moved to. The color tabs 100 and the sliding tab channel 200 are parallel with the top of the left half 10.

Additional Embodiments

One additional embodiment is where the left half 10 and the right half 30 are connected by a binding method such as a spring binding or where the central fold 20 has re-enforced cardboard in it.

Another embodiment is to have the elements of left half 10 and right half 30 switched.

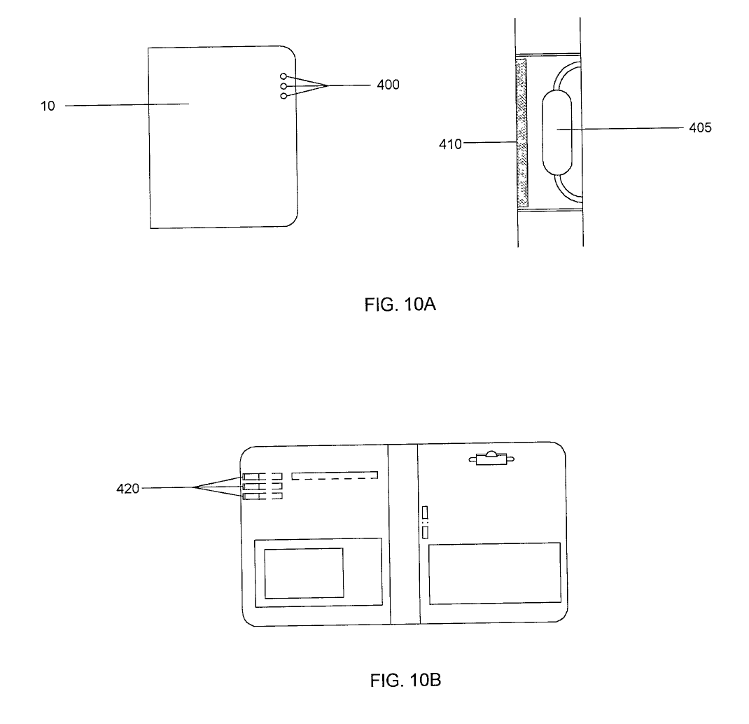

FIG. 10A shows how colored lights 400 that are visible on the lateral external surface of the right half 10 can be used instead of color tabs 100 for use as interoffice alerts and in chart routing instructions. A low power light or LED 405 will be used as a light source means. A hard semi-transparent colored lens 410 will be used to cover and protect the light and to provide a coloring means. An industry standard on/off switch 420 will be located on the lateral internal surface of the right half 10 as shown in FIG. 10B. The wiring of the such lighting wiring configuration is common in the industry and is not disclosed here. A standard 15V watch battery will be used to power the system.

Operation

In use, the electronic device 80 stays with the clinical staff, while the paper record with or without the medical folder 1 will follow the traditional routes to and from the front office area. This could consist of 3 or more scenarios. In the preferred embodiment three scenarios are given.

The 1^{st} scenario is a Paper Dominant Record The front office staff would pull and mount the paper chart of a patient to be seen into the medical folder 1. The flag system would have a color tab 100 that is used to signify that it is set for paper records. That color tab 100 is pulled out and the medical folder 1 is routed to the clinical area. A medical professional would enter data on the paper record, and leave the medical folder 1 outside the exam room. A Physician would mount the electronic device 80 and see the patient, following the flag notice to do paper data entry. If lab and x-ray results were available electronically, these would be written in the paper chart. If prescription writing is available electronically, then the data unit is utilized, with a written note to chart. The Physician removes the data unit for use with the next patient and routes the completed paper flagged medical folder 1 with chart back to the front office.

The second scenario is a Paper Transition Record. The front office enters patient data on a Computer device such as a Personal Computer and mounts the paper chart on the medical folder 1 for routing to the back office. A color tab 105 is used to signify that both paper and electronic charting will occur and it is pulled out to show it is flagged for Transition in which both paper and electronic charting will occur. A medical professional mounts the data unit and enters patient data on the electronic unit, with a notation to the paper record. The combined medical folder 1 is left for the Physician, who uses it for reviewing past visits on the paper record and entering new data electronically. Another color tab 110 is used to flag by the physician if nursing orders or dictation will be required after the visit.

The third scenario is an Electronic Dominant Record. For new patients and patients whose old records have been converted fully to electronic form, there is no need for a paper chart. Front office staff enter patient information on their computer device such as a Personal Computer, place any unscanned paper reports into the medical folder 1 and flag it for electronic charting. After routing to the back office, =medical professionals can check the paper reports, do their electronic charting and reroute the medical folder 1 to the front office for incorporation of the paper elements.

Advantages

Over time, as more electronic functionality is adapted by the practice, the reliance on paper records is diminished and eventually eliminated. When the practice uses the medical folder 1 it can be used to accommodate new patients with transferred paper charts and be used for flagging the patients with transitional records or with the occasional paper elements that continue to need attention before they can be scanned in.

This device can be used by any healthcare practitioner who currently uses a paper chart and wishes to adopt electronic medical records. The advantage of this device is that it is unique in its ability to accommodate both a paper chart and an electronic device side by side in an ergonomic fashion to allow data entry on either or both elements. In this way, the practitioner is allowed to transition incrementally from paper to electronic records at his/her own pace. As part of a medical records system, this device can uniquely help an office practice add electronic functionality over time, while fitting into whatever the existing office information flow is.

Conclusion, Ramifications, and Scope

With the need to move towards an electronic records from paper records, especially in the medical profession, the current invention helps practitioners with the increment transition from paper to electronic records at their on place. The Medical Folder solves many of the problems of moving from a paper to electronic based system.

Although the present invention has been described in considerable detail with reference to certain preferred versions thereof, other versions are possible. For example, the base could be of different dimension, a different material could be used to make it, or another electronic device can be used. Therefore, the point and scope of the appended claims should not be limited to the description of the preferred versions contained herein.

That which is claimed:

1. A device comprising:
a folder with a right half and a left half connected by a central fold with a means for holding an electronic device, a means to hold documents and a flagging means.

2. The device according to claim 1 wherein the flagging means are a plurality of colored tabs.

3. The device according to claim 1 wherein the flagging means are a plurality of colored lights.

4. The device according to claim 1 wherein the right half and the left half are made of a flexible material covering reinforced cardboard.

5. The device according to claim 1 wherein the means to hold documents is a spring clip.

6 The device according to claim 1 which includes a stylus/pen holder, a slit for pads and a loose paper pocket.

7. The device according to claim 1 wherein the connecting means for the electronic device is Velcro.

8. The device according to claim 1 where in the connection means for the electronic device is straps

9. A process of handling paper dominant records comprising
steps in which paper file records are pulled and mounted on a medical folder, the flagging means is set to paper data entry, an electronic device is mounted on the medical folder and used for data retrieval, data is entered on the paper record, and the electronic device is removed.

10. The device according to claim 9 wherein the flagging means are a plurality of colored tabs.

11 The device according to claim 9 wherein the flagging means are a plurality of colored lights.

12 The device according to claim 9 wherein the flagging means includes a flag which indicates additional information is needed.

13. A process of handling paper and electronic records comprising:
steps in which the paper file records are pulled and mounted on a medical folder, the flagging means is set for paper and electronic records, an electronic device is mounted on the folder, both the paper and electronic records are reviewed and data is entered on both the paper record and the electronic device.

14. The device according to claim 13 wherein the flagging means are a plurality of colored tabs.

15. The device according to claim 13 wherein the flagging means are a plurality of colored lights.

16. The device according to claim 13 wherein the flagging means includes a flag which indicates additional information is needed.

17. A process of handing electronic dominant records comprising:
steps in which paper records are placed in the folder, the flagging means are set for electronic charting, an electronic device is mounted on the folder, data is entered into the electronic device, and paper records are entered into an electronic record.

18. The device according to claim 17 wherein the flagging means are a plurality of colored tabs.

19. The device according to claim 17 wherein the flagging means are a plurality of colored lights.

20. The device according to claim 17 wherein the flagging means includes a flag which indicates additional information is needed.
